(19) United States
(12) Patent Application Publication
(10) Pub. No.: US 2004/0073647 A1
(43) Pub. Date: Apr. 15, 2004

(54) Method and system for checking the configuration of nodes in a telecommunications network

(76) Inventors: Gabriele Gentile, Torino (IT); Marco Areddu, Torino (IT); Riccardo Arizio, Torino (IT); Luigi De Martino, Torino (IT); Claudio Claretto, Torino (IT)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/469,502

(22) PCT Filed: Feb. 21, 2002
(86) PCT No.: PCT/IT02/00104

(30) Foreign Application Priority Data
Mar. 1, 2001 (IT) TO2001A000180

(51) Int. Cl. G06F 15/173

(52) U.S. Cl. 709/223; 455/422.1

(57) ABSTRACT

The method involves generating a model configuration (M1) of the nodes in the network (N) comprising, for each function among a plurality of node functions, a respective model of the function's operation. For each of the nodes under test, a respective set of data ( . . . , CF_{K-1}, CFₖ, CFₖ₊₁, . . . ) regarding the current configuration of the node is collected. This respective set of current configuration data is compared with the model configuration (M1) in the absence of interaction with the node under test. For some or all of the node functions, it is envisaged that this comparison will be carried out by simulating—step by step if desired—the operation of node functions, again in the absence of interaction with the node under test.

### TECHNICAL FIELD

The present invention addresses the problem of checking nodes in a telecommunications network and was developed with particular attention to the potential implementation of a centralized function for checking the configuration of the nodes in a telecommunications network such as a mobile telecommunications network, for example. The potential uses of the invention are not, however, limited to this specific application.

### BACKGROUND ART

In general, the activities involved in checking and designing the configuration data for the nodes in a telecommunications network are particularly complex and delicate.

There are many reasons underlying the complexity of these activities. Several examples of these reasons are given below, though no attempt will be made to provide an exhaustive presentation:

The majority of network activities, such as the addition of a new node (take, for example, the so-called MSC/VLR in a mobile radio network) or the deployment of a new service generally involve the need to define/redefine the data for the new/existing nodes;

As the node may be central to the network architecture (here, the example of an MSC/VLR in a mobile radio network continues to apply), defining a node's configuration data incorrectly can have deleterious effects as regards service availability;

There is a high degree of interdependence between the various categories of configuration data for a node. Consequently, tools are needed for determining the effects of varying the generic category of this data: Here a typical example is that of number analysis, which has a high degree of interdependence with billing analysis.

Node design and/or configuration activities are generally performed at different times and by different parties, even if the nodes are based on the same technology. Functions that are identical in all respects may thus be implemented using principles and criteria that are equivalent but not exactly identical, resulting in an undesirable lack of uniformity in the network.

In addition, there is a general tendency among network operators to integrate nodes and/or node components based on different technologies in the same network.

In a situation of this kind, it is clear that a number of additional needs will arise. Consequently it will be necessary to:

Provide network operators with tools for checking that the configuration data for deployed systems comply with the rules established by network operators in their design specifications,

Standardize system configuration by identifying the configuration data that should be identical for all systems on the one hand, and, on the other hand, the data that cannot be identical inasmuch as they depend on system location in the network,

Optimize system performance by identifying and eliminating any redundancies in configuration data,

Assign the function of defining reference configuration rules to a single entity, delegating the checks carried out to determine that node configuration complies with these rules to other decentralized entities (which for large networks may be geographically distributed), and

Extend checks so that they no longer consist simply of an analysis and verification function, but include (re)designing node configuration data in accordance with predetermined rules.

### DISCLOSURE OF THE INVENTION

The object of the present invention is thus to provide a solution capable of overcoming the problems outlined above and of ensuring that all of the needs indicated above can be satisfied.

In accordance with the present invention, this object is achieved by means of a method having the characteristics detailed in the following claims. The invention also relates to the associated system.

In its currently preferred embodiment, the solution in accordance with the invention makes it possible to perform configuration checks (with the objective of checking exchange data configuration by comparing it with reference specifications), as well as to carry out functional analyses (with the objective of checking the node's operation by comparing its emulated behavior with that envisaged by the reference specifications).

To accomplish configuration checks, configuration data used in operation are typically taken from one or more files associated with the node (called exchange printouts), and the operating data are compared with the reference data.

Carrying out functional analyses, on the other hand, is a more complex task.

In this connection, it should be borne in mind that—in general—a network node consists of a set, which may be fairly complex, of cooperating functions.

For example, there are functions that manage:

Called numbers,

Signal routing,

Call routing,.

Call billing, and

End-of-dialing characters.

Each function is associated with a configuration file with a known format called the exchange printout file which indicates the values for function parameters.

The configuration of the function of interest can be requested from a generic node starting from the so-called exchange printout.

To enable function checks to be carried out, the solution in accordance with the invention involves specifying and implementing software functions (called “analyzers”), each of which simulates a single node capability.

As regards call management, for example, analyzers are used to simulate called user number (B-number) management, signal routing, call routing and so forth.

From the analysis of the node's overall operating specifications, procedures are specified which make use of grouped analyzers to simulate node functions. These procedures thus make it possible to simulate an entire set of overall behavior modes on the part of the node.

The following input data are used to simulate execution of the generic procedure:

The operating configuration data for the analyzers associated with the procedure, which can be determined from the corresponding exchange printouts, and

The input parameters for the overall procedure.

The check verifies that expected operation coincides with that obtained by running the procedure for the node of interest.

To enable the user to simulate the generic function of the node step by step, an environment has been specified which makes it possible to:

Select the node of interest,

Select the analyzer of interest,

Configure the input data for the analyzer, and

Simulate the function step by step.

### BRIEF DESCRIPTION OF DRAWINGS

The following description of the invention, which is intended purely by way of example and is not to be construed as limiting, will make reference to the accompanying drawings, where:

FIG. 1 is a block diagram illustrating the possible architecture of a checking system integrated with a mobile radio network and operating in accordance with the invention,

FIG. 2 is a block diagram illustrating how a configuration check is performed in a system in accordance with the invention,

FIGS. 3 through 5 illustrate several examples of data structures involved in the check shown in FIG. 2,

FIG. 6 illustrates the structure of the functions with which the node can be modeled for the purposes of simulation in accordance with the invention, and

FIGS. 7 and 8 depict two examples of functional analysis carried out in a system in accordance with the invention.

### BEST MODE FOR CARRYING OUT THE INVENTION

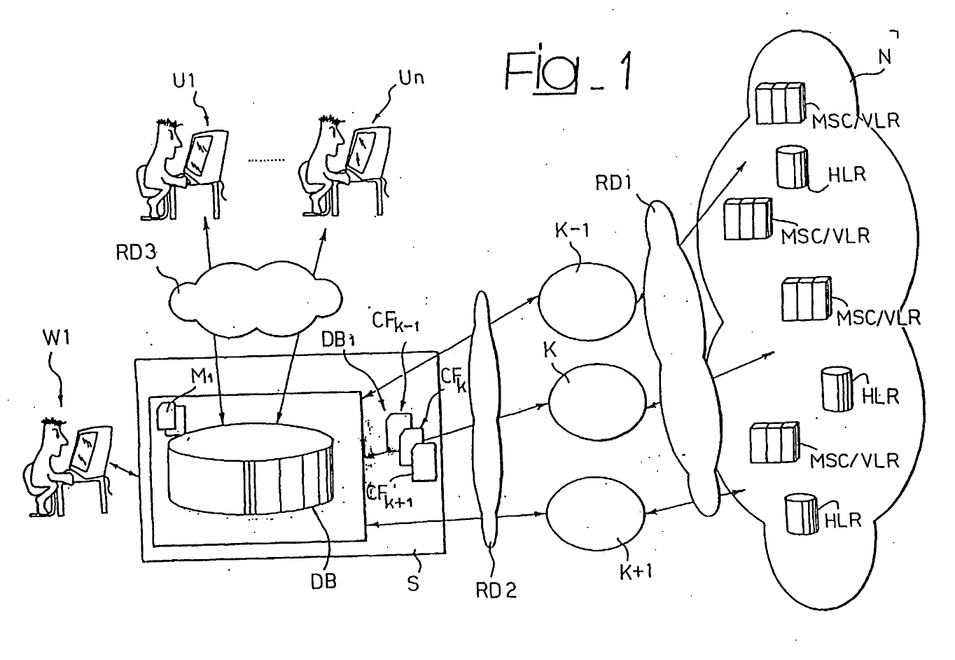

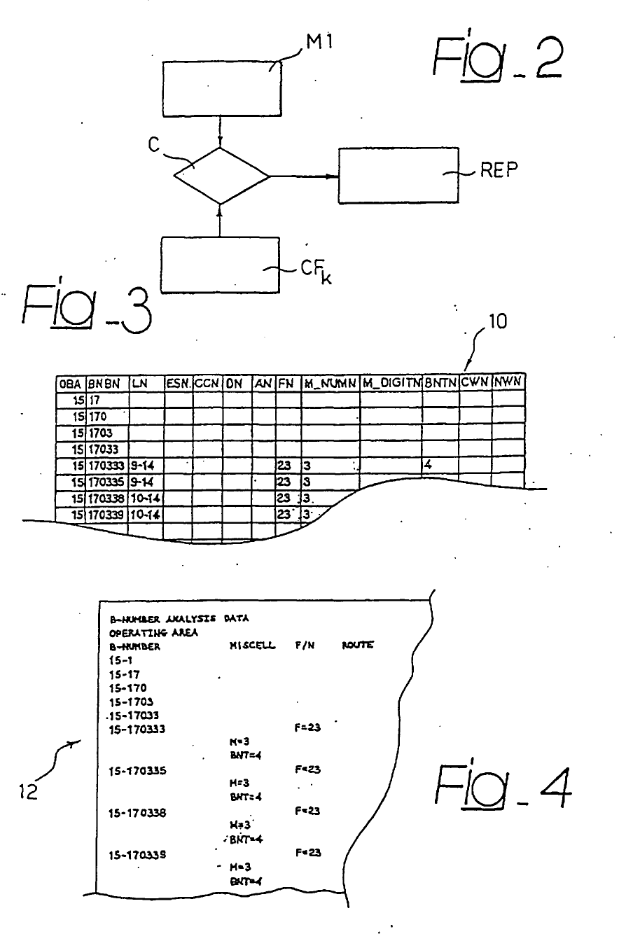

In FIGS. 1 and 2, the letter N designates a telecommunications network represented—in the embodiment which will be referred to below, but is not to be regarded as restrictive—by a mobile radio network. FIG. 1 schematically represents MSC/VLRs (Mobile Services Switching Center/Visitor Location Registers) and HLRs (Home Location Registers) connected, by means of a data network RD1, to the associated management systems, designated as k−1, k and k+1 respectively.

As indicated above, though the solution in accordance with the invention was developed with a view to potential application in checking the configuration data for a mobile radio network, all references to said potential application are not to be construed as limiting the scope of the invention, which is general.

Consequently, the network can have any general structure and be of any nature. This is true in particular of the structure and methods used to interconnect the various nodes in the network. Specifically, the fact that the three management systems represented—purely by way of example—in the figure have been designated with the references k−1, k and k+1 is in no way intended to express a connection or necessary sequential relationship of any kind between the systems.

That said, and to clarify the concepts involved by reference (again by way of example) to a mobile radio network, the management systems . . . , k−1, k, k+1, . . . typically referred to as OMCs (Operation and Maintenance Centers) are of particular importance to the network nodes. It is in these systems that the files (called exchange printouts) with the network node configuration data are collected. This data may include the following (though it should be emphasized that the list provided below is not to be regarded as either exhaustive or limiting):

Configuration data for the MSC/VLRs, TR/STP (Transit/Signaling Transfer Point) and HLRs in operation for the international roaming service;

Configuration data for the MSC/VLRs in operation for the B-number analysis function;

Configuration data for the MSC/VLRs, TR/STPs and HLRs in operation for the data area relating to the so-called “exchange properties”;

Configuration data for the MSC/VLRs in operation for the B-number pre-analysis, B-number analysis, IMSI (International Mobile Station Identity) analysis, GTS (Global Title Series) analysis, MTP (Message Transfer Part) analysis and routing analysis functions.

In accordance with known criteria (which are indicated here purely in order to orient the reader), data associated with the international roaming service are subjected to checks in relation to factors such as:

Whether the Global Title Series (E.164 and E.214 type) envisaged in the reference specifications are present in the system,

Whether the E.212 IMSI Series envisaged in the reference specifications are present in the system,

Whether the E.212 IMSI Series is correctly translated into the corresponding E.214 Global Title Series, and

Whether generic operator signaling is correctly routed.

The data associated with the B-number analysis function are fundamental for handling the numbers associated with “called” users. Typically, this function makes use of a tree type data structure, and these trees must at times be identical, either wholly or in part, in all of the MSC/VLRs in the network.

In particular, the system in accordance with the invention makes it possible to carry out configuration checks on the individual B-number analysis tree, identifying:

The number ranges in the operating MSC/VLR nodes which are in excess with respect to those envisaged by reference specifications,

The number ranges which are not present in the operating NSC/VLR nodes but are envisaged by reference specifications, and

The number ranges in the operating MSC/VLR nodes whose parameters have a different value than that envisaged by reference specifications.

All of the foregoing points correspond to principles and criteria which will be familiar to persons skilled in the art.

In any case, reference to particular functions and capabilities have been made purely by way of example, given that fundamentally similar considerations apply to all other sets of configuration data considered previously or, in general, for all configuration data typical of a node in a telecommunications network, however it may be organized and however it may operate.

For the purposes of the present invention, it will be sufficient to bear in mind that the configuration data characteristic of each node in the network are usually organized in the form of ASCII files which may be resident in the management system . . . , k−1, k, k+1, . . . and are thus capable of being collected in a database DB which constitutes the heart of the server S used in the system in accordance with the invention.

More particularly, the data corresponding to the configuration data for the individual nodes can be collected remotely by the server S, e.g., using the typical transmission modes of a data network (RD2).

Consequently, the database DB resident on the server S (or otherwise available to said server S) will have a dedicated portion designated as DB1 containing the configuration data associated with the nodes and extracted from the configuration files . . . CFₖ₋₁, CFₖ, CFₖ₊₁ . . . taken from one of more exchange printouts.

In this connection, it will be readily apparent to a person skilled in the art that, even though the files in question have been designated for the sake of simplicity with generic subscripts . . . , k−1, k, k+1, . . . , this designation should in no way be construed as indicating a correspondence between the files and management systems. This is because, for example, each system can manage multiple nodes, each with multiple files.

Another portion (designated as M1) of the database DB is dedicated to storing the data regarding a configuration which is to be used as a “model” for all nodes in the network.

In other words, the model file M1 receives the configuration data (or rather, the node configuration specifications) which must be applied uniformly on the part of all of the nodes in the network N. The model file M1 is organized by a network manager which creates the configuration model M1 through its station W1 which interacts, at local network level or remotely, with the server S.

The system in accordance with the invention makes it possible, in the first place, to check that the configuration data are all consistent (virtually identical, at least where they are required to be identical inasmuch as they are not specific to a particular node) and in any case comply with the configuration specifications established by the “model” configuration.

In the currently preferred embodiment of the invention, the system is configured in such a way as to extend the check function beyond the stage of simply verifying the situation as it exists. This is accomplished by providing a network node reconfiguration function designed to ensure that any * configuration data showing characteristics that do not match those of the “model” data can be modified in order to reach the desired condition of conformance. All of this is achieved through remote node reconfiguration, for example by transmitting the commands and data needed in order to proceed with reconfiguration to the management system, . . . , k−1, k, k+1, . . . of the node concerned in each individual case.

It will be readily apparent that this preferred method of organizing the system in accordance with the invention makes | it possible to perform a network node reconfiguration action. This action ensures that all nodes in the network will at all times be configured in mutually uniform fashion and in compliance with the reference specifications.

This operating mode makes it possible to monitor the network changes resulting, for example, from the addition of new nodes and/or the addition (or elimination) of certain functions for one or more nodes and the consequent reconfiguration of the entire network. It should be emphasized that this also applies to cases in which the network nodes are not all based on the same technology.

A characteristic feature of the solution in accordance with the invention is that it is capable of simulating generic node capabilities through functions provided for this purpose. This makes it possible to avoid any invasive impact on the network nodes.

A node can in general be modeled as a set of cooperating functions. In accordance with the invention, functions which replicate those of the nodes are defined and implemented. These functions make it possible to check both the operation of the individual nodes, and the operation of a complete network.

The functions that emulate the node's generic capabilities are defined as general-purpose functions, and the information needed to simulate the behavior of the node in question includes:

The input data used to start the function, and

The configuration data present in the exchange printout associated with the function.

In this way, operation of the generic function performed by the generic network node can be simulated without having to carry out invasive operations of any kind on the network N.

Consequently, the solution in accordance with the invention envisages that the aforesaid check will be carried out through simulation based on the criteria described in greater detail below.

The block diagram shown in FIG. 2 illustrates the criteria used by a system in accordance with the invention to implement a configuration check function, e.g., for the so-called B-number analysis trees.

Essentially, this function corresponds to a check function C performed by comparing:

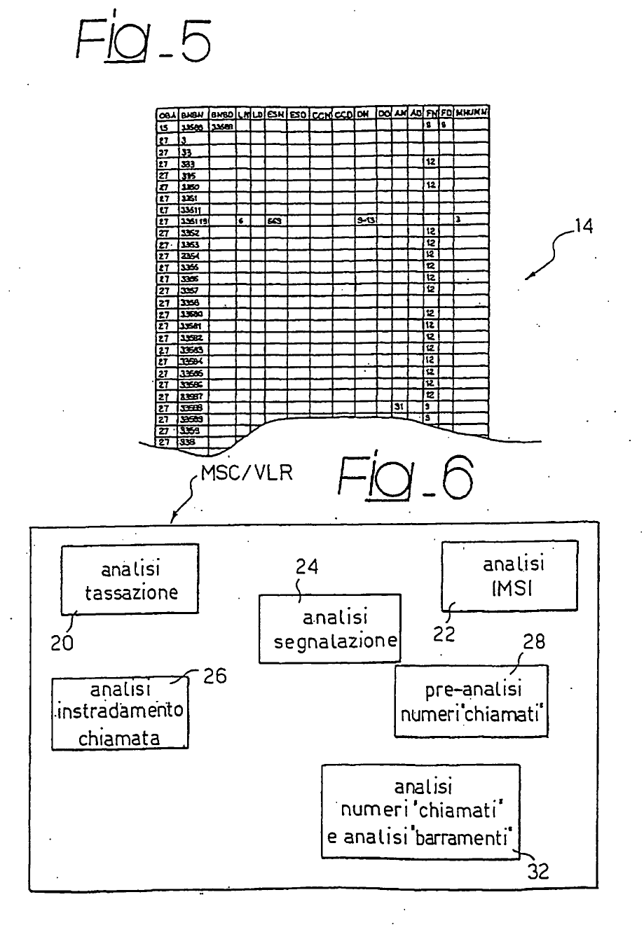

Configuration data corresponding to specifications (file M1), which can have a structure such as that designated as 10 in FIG. 3, and

The actual configuration data corresponding to the operating data collected in the associated exchange printout, and which usually have the structure designated as 12 in FIG. 4.

Starting from the comparison function designated as C, the system generates a report REP having the structure designated as 14 in FIG. 5. In practice, the report in question features a first column showing the identifier (i.e., the numerical identifier) of the tree followed by a sequence of copies of parameters where the first is the reference data (with the suffix N indicating a specification requirement) and the other is the parameter in current operation (with the suffix D indicating operating data).

In this way, the report 14 makes it possible to detect the following types of mismatch:

Numbers (indicated by a value in the BNBD field and no value in the BNBN field) in service which are in excess of those required by reference specifications;

Numbers (indicated by no value in the BNBD field and a value in the BNBN field) which are not in service but are called for by reference specifications; and

Different values of parameters for the same number (same values assigned to fields BNBD and BNBN).

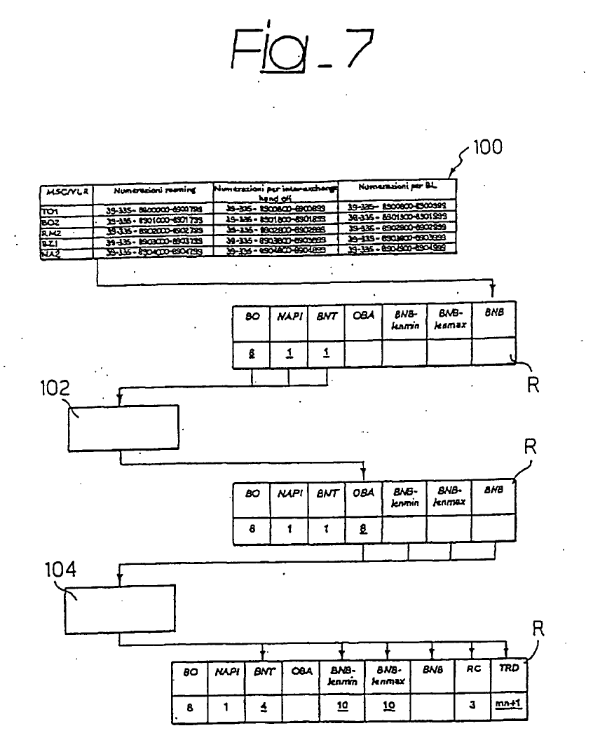

FIGS. 6, 7 and 8, on the other hand, refer to the criteria that the system in accordance with the invention uses to perform the function checks designed to determine whether the node's expected operation coincides with that obtained by running the corresponding procedure for the node in question.

In particular, the diagram shown in FIG. 6 illustrates the typical organization of an MSC/VLR in a mobile radio network, which can be seen as a set of cooperating functions that manage called or B-numbers, signal routing, call routing, call billing and end-of-dialing-characters.

Essentially, the solution in accordance with the invention is based on creating a set of software level simulation functions in the database DB, each of which is constructed on the basis of the set of rules and criteria that a given node technology uses to implement a node capability.

With reference to the case of an MSC/VLR as indicated above, for example, these functions may emulate the following at software level:

Billing analysis (20),

IMSI analysis (22),

Signaling analysis (24),

Call routing analysis (26),

B-number pre-analysis (28), and

B-number analysis and analysis of call barring, where applicable (32).

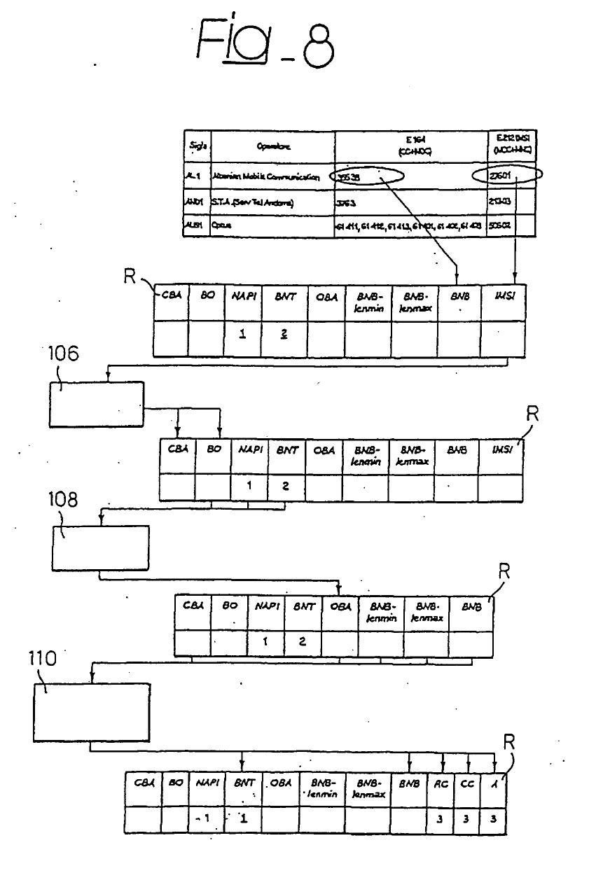

FIGS. 7 and 8 (which will be described in greater detail below) illustrate how function analysis is performed by making use of a register R, which is simply the set of the variables capable of representing:

The input data for the first function in the chain,

The data obtained as the result of the generic function and which can be used as the input data for the subsequent function, and

The data obtained as the end result of the complete chain.

In the currently preferred embodiment of the invention, it is envisaged that the checking/simulation functions are activated by a plurality of geographically distributed terminals or work stations U1, . . . , Un which are capable of interacting remotely with the system server S, for example through communication on data network DR3. In this connection, it is usually envisaged that the stations U1, . . . , Un are inhibited from interacting with the model configuration M1, which is defined solely and exclusively by station W1.

For example, each work station U1, . . . Un may be geographically located in a corresponding management area associated with a certain subset of the nodes included in network N.

This need for the work stations U1, . . . , Un to be geographically distributed is less pronounced when the system is configured in such a way that it can also perform centralized node (re)configuration from a single control station. In this latter case, it is also possible to combine the general network supervision function and simulation startup function in a single station such as station W1. In the diagrams shown in FIGS. 1 and 2, conversely, these functions are represented as being assigned separately to station W1 on the one hand, and to stations U1, . . . , Un on the other hand.

In any case, each of the stations U1, . . . , Un is able to start the simulation in order to check the operation of a node. Additionally, in the currently preferred embodiment of the invention, stations U1, . . . , Un are also able to perform step-by-step simulation of the generic operation of the node subjected to checks in each particular instance.

All of these operations are performed in an environment which makes it possible to:

Select the node of interest,

Select the analyzer of interest,

Configure the input data for the analyzer,

Configure the analyzer (in a way which is transparent to the user) by making use of the configuration data in the corresponding printout,

Simulate (step by step, if so desired) the associated function, and

Analyze the results of analysis.

For example, FIG. 7 illustrates a typical functional analysis sequence carried out in relation to routing the so-called “roaming numbers”.

In particular, after the node of interest has been selected from a list (step 100) and the corresponding information has been entered in the register R, the user chooses (step 102) the analyzer of interest (for example, the B-number pre-analysis function—block 28 in FIG. 6). Here again, the associated data are downloaded in the register R before proceeding (step 104) to select another analyzer of interest (B-number analysis, for example) and the corresponding resumption of interaction with the register R.

As will be readily apparent, the configuration data used by the various analyzers are as follows:

The input data for activating the analyzer should it be the first in the chain,

The input data provided by a previously activated analyzer, and

The configuration data taken from the printout associated with the analyzer.

This fact will also be apparent from an examination of the sequence shown in FIG. 8. This figure represents the successive changes in register R that occur during a function analysis addressing the routing of a call for the international roaming service.

In this case, steps 106, 108 and 110 correspond to selecting the IMSI analyzers as the analyzers of interest, and carrying out B-number pre-analysis, B-number analysis and analysis of any call barring.

In any case, it will be readily apparent that the analyzers' operation is based on importing printouts for the capabilities of the system of interest so that the node's behavior as regards the selected capabilities can be simulated thanks to specific software functions.

The use of each analyzer basically calls for:

Selecting the system,

Selecting the function of interest, and

Introduction on the part of the user of the input data that are essential for the first function in the chain.

Naturally, and without detriment to the invention's underlying principles, details and forms of implementation may vary widely with respect to the descriptions and illustrations provided herein, without for that reason failing to fall within the scope of the present invention.

1. A method for checking the configuration of nodes in a telecommunications network (N), characterized in that it comprises the operations of:
Generating a model configuration (M1) of the nodes of said network (N), said model configuration comprising, for each function among a plurality of node functions, a respective model of the function's operation,
Collecting, for each node under test, a respective set of data ( . . . , CFₖ₋₁, CFₖ, CF_{k+2,} . . . ) regarding the current configuration of the node, and
Checking (C), for each node under test and in the absence of interaction with the node, the correspondence between said current configuration and said model of the function's operation comprised in said model configuration (M1).

2. A method in accordance with claim 1, characterized in that it also comprises the operations of:
Simulating (20 through 32), on the basis of said respective set of data and in the absence of interaction with the node under test, the operation of the corresponding node functions by generating, for each function, the outcome of current operation on the part of the node under test, and
Checking (C) the correspondence between said outcome of current operation as obtained through simulation and the corresponding model of the function's operation comprised in said model configuration.

3. A method in accordance with claim 1 or claim 2, characterized in that it comprises the operation of modifying the data comprised in said respective set of data ( . . . , CFₖ₋₁, CFₖ, CF_{k+1,} . . . ) regarding the current configuration of each node under test in order to obtain the correspondence between said current configuration and said model of the function's operation comprised in said model configuration (M1).

4. A method in accordance with any of claims 1 through 3, characterized in that it comprises the operation of providing a management station (W1) for generating said model configuration (M1).

5. A method in accordance with any of the foregoing claims, characterized in that it comprises the operation of providing a plurality of stations (U1, . . . , Un) capable of initiating said checking operation (C).

6. A method in accordance with claim 5, characterized in that said stations (U1, . . . , Un) are inhibited from interacting with said model configuration (M1).

7. A method in accordance with claim 4 or claim 5, characterized in that each of said stations (U1, . . . , Un) is configured to cooperate with a respective subset of nodes ( . . . , k−1, k, k+1, . . . ) in said network (N).

8. A method in accordance with any of claims 3 through 7, characterized in that at least one, and preferably all, of said operations of generating, collecting, simulating, checking and modifying are configured so as to be carried out from a location which is central with respect to said nodes under test.

9. A method in accordance with any of the foregoing claims, characterized in that it comprises the operation of collecting said respective set of data ( . . . , CFₖ₋₁, CFₖ, CF_{k+1,} . . . ) as a file in a database (DB).

10. A method in accordance with any of claims 1 through 9, characterized in that said model configuration (M1) constitutes at least part of a corresponding database (DB).

11. A method in accordance with any of claims 1 through 10, characterized in that said respective set of data ( . . . , CF_{K-1}, CF_{K}, CF_{K+1,} . . . ) is collected starting from the printouts of a corresponding management system ( . . . , k−1, k, k+1, . . . ) for the nodes in the network (N).

12. A method in accordance with claim 2, characterized in that said operation of simulating is carried out on the basis of at least one respective set of analysis functions (20 through 32) constituting a respective node model.

13. A method in accordance with claim 12, characterized in that said operation of simulating is carried out step by step.

14. A system for checking the configuration of nodes in a telecommunications network (N), characterized in that it comprises:
A database (DB) containing a model configuration (MI) of the nodes in said network (N), said model configuration comprising, for each function among a plurality of node functions, a respective model of the function's operation; said database (DB) also comprising, for each node under test, a respective set of data ( . . . , CFₖ₋₁, CFₖ, CF_{k+1,} . . . ) regarding the current configuration of the node, and
A check module (C) for checking, for each node under test and in the absence of interaction with the node, the correspondence between said current configuration and said model of the function's operation comprised in said model configuration (M1).

15. A system in accordance with claim 14, characterized in that it comprises:
A simulation model (20 through 32) for simulating, on the basis of said respective set of data and in the absence of interaction with the node under test, the operation of the corresponding node functions by generating, for each function, the outcome of current operation on the part of the node under test, and
Said check module (C), configured to check the correspondence between said outcome of current operation as obtained through simulation and the corresponding model of the function's operation comprised in said model configuration.

16. A system in accordance with claim 14 or claim 15, characterized in that the system is configured to modify the data comprised in said respective set of data ( . . . , CFₖ₋₁, CFₖ, CF_{k+1,} . . . ) regarding the current configuration of each node under test in order to obtain the correspondence between said current configuration and said model of the function's operation comprised in said model configuration (M1).

17. A system in accordance with any of claims 14 through 16, characterized in that it comprises a management station (W1) for generating said model configuration (M1).

18. A system in accordance with any of the foregoing claims 14 through 17, characterized in that it comprises a plurality of stations (U1, . . . , Un) capable of controlling said check module (C).

19. A system in accordance with claim 18, characterized in that said stations (U1, . . . , Un) are inhibited from interacting with said model configuration (M1).

20. A system in accordance with claim 18 or claim 19, characterized in that each of said stations (U1, . . . , Un) is configured to cooperate with a respective subset of nodes ( . . . , k−1, k, k+1, . . . ) in said network (N).

21. A system in accordance with any of claims 14 through 20, characterized in that at least one, and preferably all of said databases (DB) and said check module (C) are located centrally with respect to said nodes ( . . . , k−1, k, k+1, . . . ) under test.

22. A system in accordance with any of the foregoing claims 14 through 21, characterized in that said respective set of data ( . . . , CFₖ₋₁, CFₖ, CF_{k+1,} . . . ) constitutes a file in a respective database (DB).

23. A system in accordance with any of claims 14 through 19, characterized in that said model configuration (M1) constitutes at least part of a corresponding database (DB).

24. A system in accordance with any of claims 14 through 23, characterized in that said database (DB) interacts, for the purposes of collecting said respective set of data ( . . . , CK_{K-1}, CF_{K}, CF_{K+1,} . . . ), with a corresponding management system ( . . . , k−1, k, k+1, . . . ) for the nodes in the network (N), collecting printouts from the management system.

25. A system in accordance with claim 15, characterized in that said simulation model comprises a respective set of functions (20 through 32) for simulating the respective capabilities.

26. A system in accordance with claim 25, characterized in that said simulation model performs simulation on a step-by-step basis.
